(19) United States
(12) Patent Application Publication
(10) Pub. No.: US 2025/0377655 A1
(43) Pub. Date: Dec. 11, 2025

(54) METHOD AND TEST SYSTEM FOR FORWARDING ETHERNET MESSAGES

(71) Applicant: dSPACE GmbH, Paderborn (DE)

(72) Inventors: Ralf GROSSE BOERGER, Paderborn (DE); Ralf STOLPE, Paderborn (DE); Tobias SCHAEFFER, Paderborn (DE)

(73) Assignee: dSPACE GmbH, Paderborn (DE)

(21) Appl. No.: 19/231,258

(22) Filed: Jun. 6, 2025

(30) Foreign Application Priority Data
Jun. 7, 2024 (DE) 10 2024 115 915.4

(51) Int. Cl. G05B 23/02

(52) U.S. Cl. CPC G05B 23/0256

(57) ABSTRACT

A method for passing and manipulating messages of a first control unit and a second control unit through a test system. The test system is connected via a first port to the first control unit and via a second port to a source and/or sink for the messages of the second control unit. The test system has a first controller and a first TCP/IP stack for the messages of the first control unit and a second controller and a second TCP/IP stack for the messages of the second control unit as well as a message memory for exchanging messages with the first TCP/IP stack and the second TCP/IP stack. Messages from the first TCP/IP stack are transferred to the message memory and forwarded to the second TCP/IP stack and vice versa, wherein messages can be selected via a first program in order to be manipulated for test purposes before forwarding.

This nonprovisional application claims priority under 35 U.S.C. § 119 (a) to German Patent Application No. 10 2024 115 915.4, which was filed in Germany on Jun. 7, 2024, and which is herein incorporated by reference.

### BACKGROUND OF THE INVENTION

### Field of the Invention

The invention relates to a method for passing and manipulating messages, which are exchanged between a first and second control unit, via a test system.

### Description of the Background Art

A method or test system is used for hardware-in-the-loop (HIL) tests, for example, when the communication between two control units, such as in the automotive sector, needs to be tested.

The test system is connected via a first port to the first control unit and via a second port to a source and/or sink for the messages, to be sent and/or received, of the second control unit. It has a first controller and a first TCP/IP stack for the messages of the first control unit and a second controller and a second TCP/IP stack for the messages of the second control unit as well as a message memory for exchanging messages with the first TCP/IP stack and the second TCP/IP stack. In the test system, messages from the first TCP/IP stack are transferred to the message memory and forwarded to the second TCP/IP stack and vice versa; i.e. communication can also be bidirectional. In this regard, messages can be selected by means of a first program, for example, via a user specification for an IP address, a port number, or an element from an AUTOSAR description file, in order to be manipulated for test purposes before forwarding. One such initial program is provided, for example, by the Ethernet Configuration Package from the company dSPACE GmbH. This tool also takes care of the forwarding of messages, the corresponding configuration of the communication for the test, and the manipulation of the messages. The first program is stored on the test system or on a PC connected to the test system for configuration purposes. It can also consist of a plurality of programs or modules. An application, i.e., an executable application program for carrying out a test method on the test system, is generated by means of the first program.

DE 10 2021 125399 A1, which corresponds to US 2024/0241491, which is incorporated herein by reference, shows a method and such a test system in which a HIL simulator is connected as a test system between communication participants.

The communication participants can be control units directly but also sources and/or sinks for messages from control units, such as, e.g., a replay system from which previously recorded messages are played back.

In the test system of DE 10 2021 125399 A1, the messages of a control unit are forwarded from the first or second controller to the corresponding first or second TCP/IP stack (depending on the port at which they were received) and stored from there in the message memory, from where they are either forwarded only to the corresponding other TCP/IP stack or also manipulated beforehand. All messages are then forwarded to the corresponding further controller.

However, in the conventional systems, much time is lost in this process in the test system in the communication between the communication participants.

### SUMMARY OF THE INVENTION

It is therefore an object of the invention to further develop the conventional art.

In an example of the method of the invention, the test system has a filter program, wherein the filter program is implemented by a parameterizable filter code, wherein the messages not selected for manipulation are transferred by means of the filter program from the first controller directly to the second controller or vice versa. In this case as well, the method can also be carried out bidirectionally.

The filter program receives the message packets that are not selected at the driver level of the message controller (e.g., Ethernet controller) before they are forwarded to the TCP/IP stack. The filter program can be implemented, for example, as a mechanism of the test system kernel.

The system gains significantly in performance when passing messages if the messages do not have to be routed via the TCP/IP stack and the driver.

For the filtering, a port number, an IP address of the sender and/or recipient of the message to be manipulated, or an indication of an element related to the message to be manipulated are received from an AUTOSAR description file. In particular, the parameterizable filter code makes it possible to receive these parameters at runtime. In the case of service-based communication, this enables the filter parameters to be transferred after service discovery, i.e., also at runtime. The parameters can be transferred to the filter program either by the first program or by the user by means of a user interface or a file.

The filter program is implemented in hardware. This enables an even more rapid execution of the filtering process. In this case, the first controller and the second controller can be implemented together with the filter program on a common programmable network card. For implementation in hardware, the parameterizable filter code (usually a functionally or semantically restricted C code in which, e.g., no pointers can be used) is translated into a simple byte code that the network card can execute directly.

The protocol fields of the Ethernet messages, received on layer 2 (data link layer in the OSI model) from the first controller, on layer 3 (network layer in the OSI model) and/or layer 4 (transport layer in the OSI model) can be inspected via the filter program in order to decide whether a message is to be forwarded directly to the second controller. The same applies to the opposite direction of communication.

An XDP (eXpress Data Path) path can be used for the filtering of the messages. It is used in conjunction with the so-called extended Berkeley Packet Filter (eBPF). The functionalities of the eBPF program are integrated, for example, by default into the kernel of the Linux operating system. This operating system can also be used for the test system. The XDP filter is an early so-called “hook” in the receive path of the kernel. It is placed in the driver of the network interface controller (NIC) directly after the interrupt handling and the memory allocation for the stack.

The messages can be Ethernet messages for service-based communication. The filter program can then be parameterized at runtime, after completion of the so-called service discovery phase, while information is exchanged to determine which participants are exchanging which messages. The filter program can then be parameterized by transferring the current port numbers and IP addresses for the messages as parameters to the filter program.

The filter code for the XDP filter is written as program code, usually as C code. This is then compiled into an eBPF program, loaded into the kernel, and activated so that it can be used there. Activation takes place via a “software switch,” i.e., a setting in the software that causes the filter program not only to be loaded but also to be executed in the test run. Such a software switch can also be used in the implementation of the filter in hardware.

Filter criteria such as port numbers, which are only known after the service discovery, may only appear as parameters in the filter code and can therefore only be transferred at runtime (in particular after the service discovery). It is therefore not necessary for these parameters to be made known to the filter program before the simulation.

It is preferably enabled to set a plurality of filter settings simultaneously or to combine filter settings. More complex conditions can thus be tested.

The parameterization of the filter program for configuring the selection of messages to be manipulated can be carried out via a graphical user interface. In this version, the filter parameters such as port numbers, IP addresses, or IDs are entered by the user in the graphical user interface or selected from a selection list. In the background, pre-written code snippets for the filter code are then combined and the filter code is generated without the user having to write any code themselves.

The graphical user interface can also be designed as part of the first program.

A first switch device can be connected between the first control unit and the first port, and the first control unit can thus be connected to the test system via the first switch device, wherein the first switch device can be connected to the first controller. In this case, a third control unit is connected to the test system via the first switch device and the first port, and messages of the second control unit are also sent to the third control unit from the first controller and/or messages of the third control unit are received and forwarded to the second control unit by the test system and, if necessary, manipulated beforehand, wherein the messages that are not selected for manipulation are forwarded directly from the first controller to the second controller by means of the filter program or vice versa (depending on the direction of communication).

The method of the invention is therefore not limited to testing the communication between two control units but can be extended to a larger number of control units. Messages of the second control unit that are received at the second port and thus at the second controller and are routed through the test system are sent from the first controller to the first switch device, which sends the messages to the first or third control unit according to their destination. Thus, an entire network of control units can be connected to the switch device.

The source and/or sink for the messages of the second control unit (i.e., messages to be sent and/or received) can be provided by the second control unit itself or by a TAP or a further switch device or a further message memory (i.e., by a playback or a so-called replay system, from which stored messages of a previous recording are played back). In this way, either the direct communication between two control units can be tested if the test system is connected between the two control units, or it is possible to test how a control unit reacts to stored messages from a previous communication. The messages of the second control unit can also be tapped from it via a TAP (Test Access Point) and sent to the first control unit via the test system, or messages for the second control unit can be received at the TAP and forwarded to the second control unit. It is also possible for the test system to be connected via another switch device to a network of a plurality of control units, which send messages to and receive messages from the first control unit.

As previously described, the first control unit can also be connected to the test system via a first switch device only indirectly via the first port, wherein further control units can also be connected to the first switch device. It is thus made possible to test and manipulate communication between two networks.

Whether the first control unit is directly or indirectly connected to the test system is usually not explicitly differentiated here.

The object is also achieved by a test system which is set up to carry out the method of the invention, wherein the test system, in an example, has a computing unit, a first port, a first controller and a first TCP/IP stack for the messages of the first control unit, and a second port, a second controller, and a second TCP/IP stack for the messages of the second control unit, as well as a message memory for exchanging messages with the first TCP/IP stack and the second TCP/IP stack. Further, the test system has a first program that is set up to transfer messages from the first TCP/IP stack to the message memory and to forward them to the second TCP/IP stack, and vice versa. The test system has a first program that is set up to receive a selection criterion for messages in order to manipulate the selected messages before forwarding them. The test system has a filter program, wherein the filter program is implemented by a parameterizable filter code, wherein the test system is set up to transfer the messages selected for manipulation from the first controller directly to the second controller by means of the filter program or vice versa. The filter program can be composed of a plurality of programs.

Consequently, the messages do not have to take the long and time-consuming route via the TCP/IP stacks and the message memory.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a schematic view of a test system connected between two control units;

FIG. 2 is a schematic view of the path of the messages through the test system in the prior art;

FIG. 3 is a schematic view of the path of the messages through the test system of the invention;

FIGS. 4A and 4B are schematic views of the path of the messages through the test system of the invention, wherein the control units are connected to the test system in different configurations; and

FIG. 5 is a schematic view of the path of the messages through the test system of the invention, wherein the filter program is implemented at hardware level.

### DETAILED DESCRIPTION

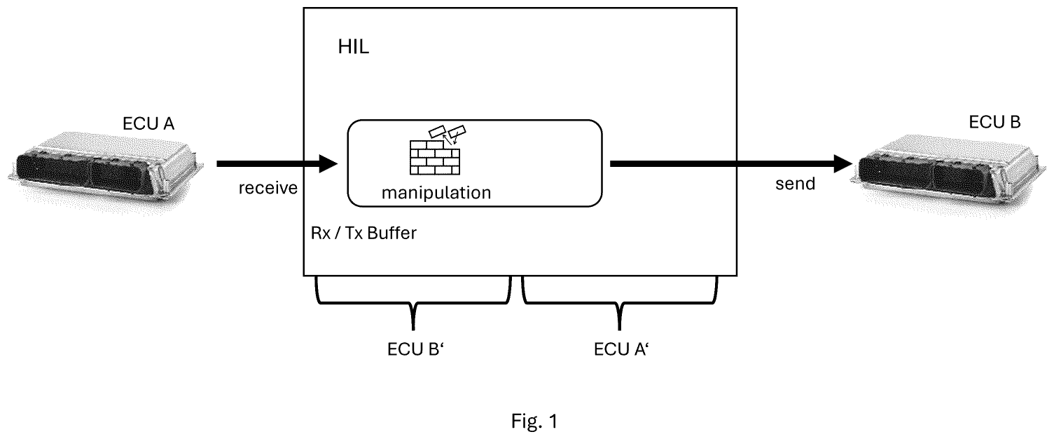

The illustration in FIG. 1 shows a test system (HIL) that receives messages from a first control unit ECU A, stores them in an Rx/Tx message memory, and manipulates them using a first program before the messages are sent to a second control unit ECU B. In order to be transparent for the control units, the test system (HIL) accepts the messages of the first control unit ECU A as a simulated second control unit ECU B′, which cannot be distinguished from the real second control unit ECU B by the first control unit ECU A, because all reactions, names, and identifiers are imitated exactly. In the same way, during the further sending of the messages to the second control unit ECU B, the first control unit ECU A is imitated by a simulated control unit ECU A′, so that the second control unit ECU B is given the impression that it is receiving the messages directly from the first control unit ECU A. Mutatis mutandis, communication runs in the opposite direction via the test system (HIL) when messages are sent from the second control unit ECU B to the first control unit ECU A and received there. In the following, only one direction is shown in the figures.

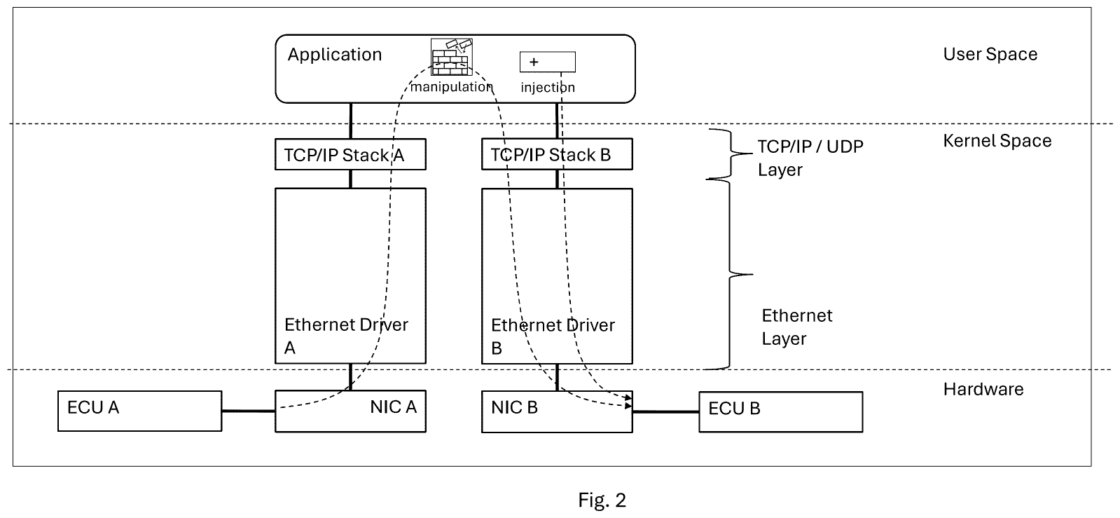

The diagram in FIG. 2 schematically shows the path of the messages through the test system (HIL).

First, the messages of the first control unit ECU A are received by a first network interface controller NIC A at the hardware level. An Ethernet driver A, which provides the software commands for processing the messages by the first controller, is assigned to the first controller NIC A at the kernel level. All messages are forwarded to the first TCP/IP stack A by means of Ethernet driver A. This is located in the TCP/IP or UDP layer of the system (layer 4 of the OSI model). This stack is used by an executable application which is created by the first program and is stored at the user level of the test system in order to undertake a manipulation of messages in a message memory, if necessary. It is also possible for the executable application to add further, new messages to the message flow, which is also known as injection. The messages to be sent subsequently to the second control unit ECU B are transferred from the message memory to the second TCP/IP stack B.

The messages are sent from the second network interface controller NIC B to the second control unit ECU B via this second TCP/IP stack B and by means of the second Ethernet driver B. Messages from the second control unit ECU B reach the first control unit ECU A via the reverse path. In principle, the method can be used bidirectionally.

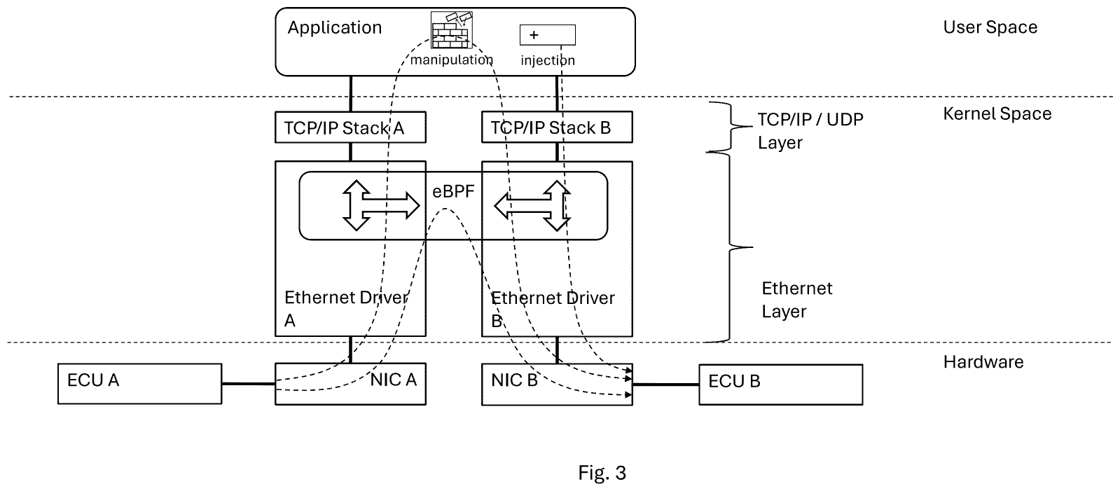

FIG. 3 now shows the test system with an extension of the invention by a filter program eBPF, which is provided in the driver level. This filter program causes only certain messages to be included in the TCP/IP stacks. For example, the filter code could look like the following, for instance:

```
  IF (EthFrame.UDPHeader.DestinationPort == 30495)
  Forward to IP-Stack and Application # frame needs to be manipulated
  ELSE
  Forward to the other NIC # frame can be forwarded without
manipulation
```

This filter program only allows the driver to transfer messages with the destination port 30495 to the TCP/IP stack. All other messages are transferred directly to the second driver B. They do not have to be allocated for the stack and can be sent directly further to the second control unit ECU B.

More complex conditions can also be implemented for the filtering, e.g.:

IF ((EthFrame.UDPHeader.DestinationPort == 30495) &&
EthFrame.SrcMACAddress == 01:02:03:04:05:06)

Both a specific destination port and a specific address must be specified here for the message to be sent via the user level.

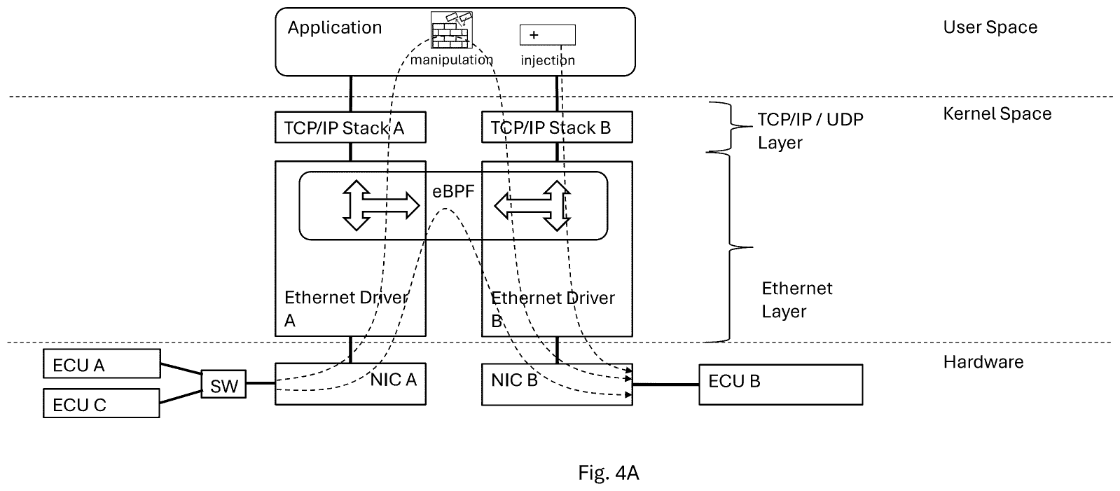

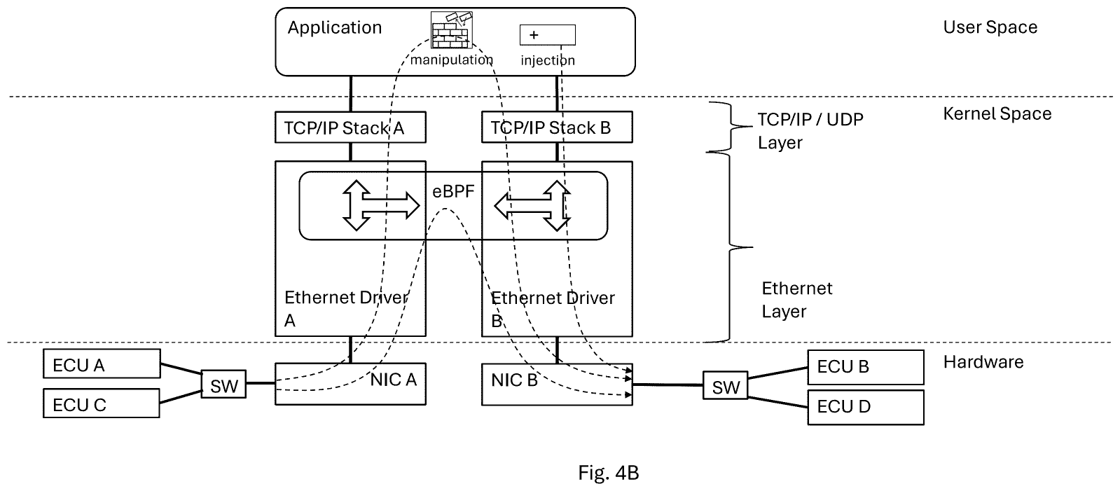

FIG. 4A schematically shows an example of the invention in which two control units, namely, the first control unit ECU A and a third control unit ECU C, are connected to the first controller NIC A via a first switch unit SW. In this case, the third control unit ECU C must also be simulated by the simulator for the second control unit ECU B.

FIG. 4B shows another variation, where the second control unit ECU B is not connected to the test system directly but via a switch SW. A fourth control unit ECU D is connected to the switch SW. In this setup, messages from the first control unit ECU A and/or the third control unit ECU C can be routed to the second control unit ECU B and/or the fourth control unit ECU D via the test system. The reverse direction of communication is also possible. In this case, the fourth control unit must also be simulated by means of the test system for its communication partners on the other side of the test system.

A switch SW, via which messages from a plurality of control units ECU A, ECU B, ECU C, ECU D are received and forwarded by the test system, is therefore connected to both the first and second controller. The test system can therefore be connected between networks of control units in order to pass, intercept, or manipulate messages, transparent for the control units, for test purposes.

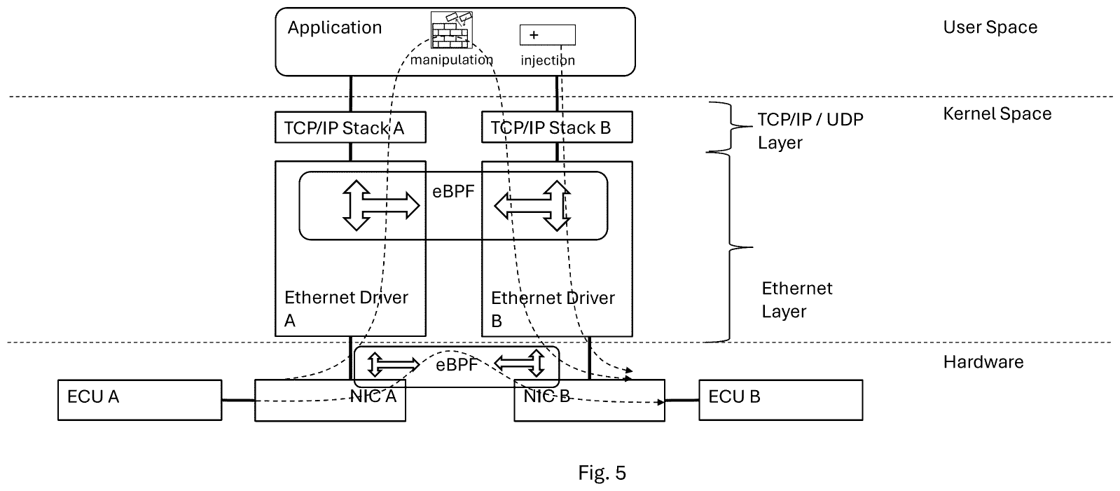

FIG. 5 shows an example of the invention in which the filter program is implemented at the hardware level. This example can be implemented if the controllers NIC A and NIC B are located on the same network card.

The invention being thus described, it will be obvious that the same may be varied in many ways. Such variations are not to be regarded as a departure from the spirit and scope of the invention, and all such modifications as would be obvious to one skilled in the art are to be included within the scope of the following claims

What is claimed is:

1. A method for passing and manipulating messages of a first control unit and a second control unit through a test system, the method comprising:
connecting the test system via a first port to the first control unit and via a second port to a source and/or sink for the messages of the second control unit;
providing the test system with a first controller and a first TCP/IP stack for the messages of the first control unit and a second controller and a second TCP/IP stack for the messages of the second control unit as well as a message memory for exchanging messages with the first TCP/IP stack and the second TCP/IP stack;
transferring, in the test system, messages from the first TCP/IP stack to the message memory and forwarding the messages to the second TCP/IP stack and vice versa;
selecting messages via a first program in order to be manipulated for test purposes before forwarding;
forwarding the messages selected for manipulation from the first or second controller to the corresponding first or second TCP/IP stack and storing the messages selected for manipulation in the message memory and manipulating the messages selected for manipulation;
forwarding the manipulated messages to the corresponding further controller;
providing the test system with a filter program that is implemented by a parameterizable filter code; and
transferring the messages that are not selected via the filter program from the first controller directly to the second controller or vice versa.

2. The method according to claim 1, wherein for the filtering, a port number, an IP address of the sender and/or recipient of the message to be manipulated, or an indication of an element related to the message to be manipulated are received from an AUTOSAR description file by the filter program at runtime.

3. The method according to claim 1, wherein the filter program is implemented in hardware.

4. The method according to claim 1, wherein protocol fields of the Ethernet messages, received on layer 2 from the first controller, on layer 3 and/or layer 4 are inspected via the filter program in order to decide whether a message is to be forwarded directly to the second controller.

5. The method according to claim 1, wherein the filter program is at least partially provided by an XDP filter.

6. The method according to claim 1, wherein the messages are Ethernet messages for a service-based communication and wherein the parameterization of the filter code takes place at runtime, after completion of the service discovery phase, by transferring the current port numbers and IP addresses for the messages to be manipulated as parameters to the filter program.

7. The method according to claim 6, wherein a parameterized program code is generated for the filter program and then compiled and used with an extended Berkeley Packet Filter program.

8. The method according to claim 1, wherein a plurality of filter settings is set.

9. The method according to claim 1, wherein the parameterization of the filter program is carried out via a graphical user input in order to configure the selection of messages for the manipulation.

10. The method according to claim 1, wherein a first switch device is connected between the first control unit and the first port and the first control unit is connected to the test system via the first switch device, wherein the first switch device is connected to the first controller, wherein a third control unit is connected to the test system via the first switch device and the first port, wherein messages of the second control unit are sent to the third control unit via the first controller and/or messages of the third control unit are received and forwarded to the second control unit by the test system and, if necessary, manipulated beforehand, and wherein the messages that are not selected for manipulation are forwarded directly from the first controller to the second controller via the filter program or vice versa.

11. The method according to claim 1, wherein the source and/or sink for the messages of the second control unit are provided by the second control unit itself or by a TAP or a further switch device or a further message memory or a replay system.

12. A test system for carrying out the method according to claim 1, the test system comprising:
a computing unit;
a first port;
a first controller;
a first TCP/IP stack for the messages of the first control unit;
a second port;
a second controller;
a second TCP/IP stack for the messages of the second control unit;
a message memory for exchanging messages with the first TCP/IP stack and the second TCP/IP stack;
a first program set up to transfer messages from the first TCP/IP stack to the message memory and to forward them to the second TCP/IP stack and vice versa, wherein the first program is set up to receive a selection criterion for messages in order to manipulate the selected messages before forwarding them for test purposes; and
a filter program implemented by a parameterizable filter code, wherein the test system is set up to transfer the messages, not selected for manipulation, from the first controller directly to the second controller via the filter program or vice versa.
